(19) United States
(12) Patent Application Publication
(10) Pub. No.: US 2008/0100718 A1
(43) Pub. Date: May 1, 2008

(54) Wireless Adapter for a Digital Camera

(75) Inventors: Ronald A. Louks, Durham, NC (US); Nadi Sakir Findikli, Cary, NC (US); Patrik H. Lilja, Raleigh, NC (US); Gerard James Hayes, Wake Forest, NC (US)

Correspondence Address: COATS & BENNETT/SONY ERICSSON, 1400 CRESCENT GREEN, SUITE 300, CARY, NC, 27511, US

(73) Assignee: Sony Ericsson Mobile Communications AB, Lund (SE)

(21) Appl. No.: 11/751,761

(22) Filed: May 22, 2007

Related U.S. Application Data
(60) Provisional application No. 60/863,383, filed on Oct. 29, 2006.

(51) Int. Cl. H04N 5/232

(52) U.S. Cl. 348/211.2; 348/E05.024

(57) ABSTRACT

A wireless adapter for a digital camera enables communications between the digital camera and remote devices over a wireless network. The wireless adapter comprises a wireless interface for communicating with remote devices, a housing for enclosing said wireless interface, a mechanical connector on said housing to mechanically connect the wireless adapter to the digital camera, and a camera interface to electrically connect the wireless adapter with the digital camera.

### RELATED APPLICATIONS

This application claims the benefit of U.S. Provisional Patent Application 60/863,383 filed Oct. 29, 2006, which is incorporated herein by reference.

### BACKGROUND

The present invention relates generally to digital cameras and, more particularly, to wireless adapters for digital cameras to enable digital cameras to communicate with remote devices.

A digital camera is an electronic device for capturing and storing images electronically instead of on photographic film. Modern digital cameras have many advantages over conventional film cameras and have virtually replaced film cameras in the marketplace. Digital cameras are small, lightweight, and inexpensive to operate since no film is required. Digital cameras allow consumers to view images immediately after they are captured. Consumers can delete images they do not like and retake images. Images captured can be uploaded to photo libraries on the user's home computer or imported into photo-editing software.

Digital cameras typically include a USB or Firewire port for connecting the digital camera to the user's home computer. A cable plugs into the camera at one end and the computer at the other end. There are many circumstances in which a user may want to send images wirelessly to remote devices. Because many home computers now have wireless interfaces, it would be convenient for consumers to connect to home computers using a wireless interface. Further, long range wireless interfaces would enable users of digital cameras to access remote devices and services from whatever location the user may currently be in.

To date, wireless interfaces have not been used in digital cameras for several reasons. Wireless interfaces increase the size, weight, and cost of the digital camera. Further, the batteries for most digital cameras are not sufficient to power a wireless transceiver. These design challenges have so far prevented use of wireless interfaces in small, portable digital cameras.

### SUMMARY

The present invention provides a wireless adapter for a digital camera to enable communication between the digital camera and remote devices over a wireless network. The wireless adapter comprises a detachable module that can be connected to and disconnected from the digital camera. The wireless adapter can be used with both digital still cameras and digital video cameras.

In one exemplary embodiment, the wireless adapter comprises at least one wireless interface for communicating with remote devices over a wireless network, a housing to enclose the wireless interface, a connector on the housing to detachably connect the wireless adapter to the digital camera, and a camera interface to electrically connect the wireless adapter to the digital camera. The wireless interface may include one or more antennas. The antennas can be fixed or movable. If two or more antennas are used, the antennas can operate in different frequency bands, or may be used to provide diversity.

### BRIEF DESCRIPTION OF THE DRAWINGS

FIG. 1 is a schematic diagram of an exemplary wireless networking environment in which a digital camera of the present invention may operate.

FIG. 2 is a block diagram of an exemplary wireless adapter for a digital camera according to one exemplary embodiment.

FIGS. 3A and 3B illustrate a first exemplary method for connecting a wireless adapter to a digital camera.

FIGS. 4A and 4B illustrate a second exemplary method for connecting a wireless adapter to a digital camera.

FIGS. 5A and 5B illustrate a third exemplary method for connecting a wireless adapter to a digital camera.

FIGS. 6A and 6B illustrate a fourth exemplary method for connecting a wireless adapter to a digital camera.

FIGS. 7A-7C illustrate an antenna arrangement for a wireless adapter for a digital camera having a single antenna

FIG. 8A-8C illustrate an antenna arrangement for a wireless adapter for a digital camera having two antennas.

FIGS. 9A-9D illustrate antenna arrangements for a wireless adapter for a digital video camera.

### DETAILED DESCRIPTION

Referring now to the drawings, a wireless adapter 100 for a digital camera 10 is shown. The wireless adaptor 100 enables wireless communications between the digital camera 10 and remote devices or services, such as a home computer 30, web album 32, web blog 34, or remote print server 36 over a wireless network. The wireless adapter 100 can be used with both digital still cameras and digital video cameras. The wireless adapter 100 detachably connects to the digital camera 10 and provides remote access capability to the digital camera 10 that otherwise lacks inherent wireless networking capabilities.

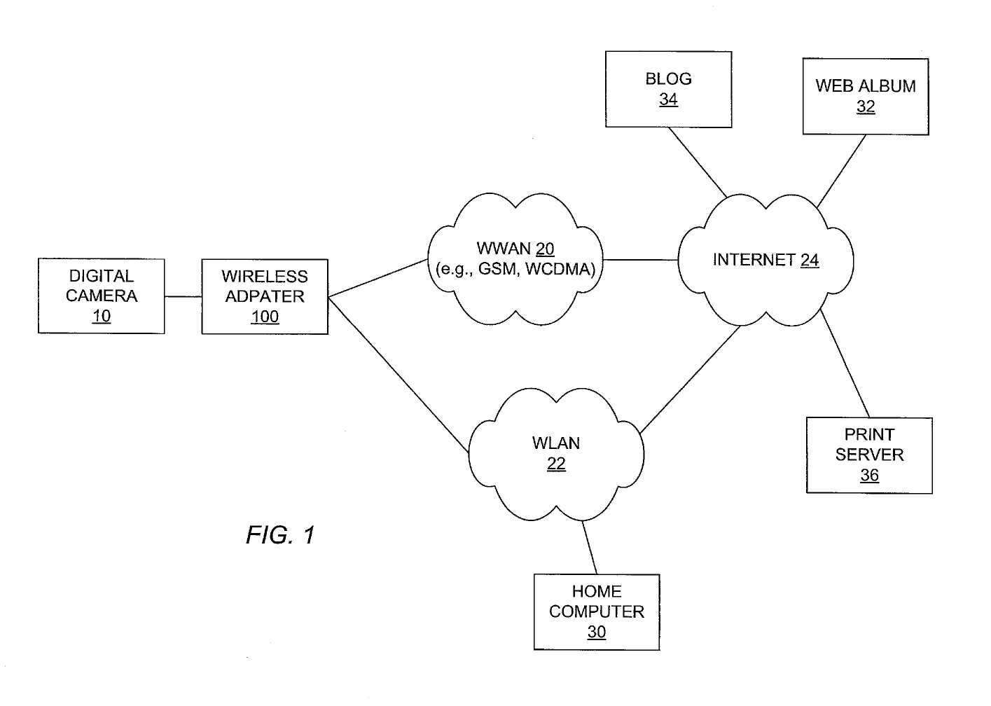

FIG. 1 shows an exemplary networking environment in which the wireless adapter 100 can be used. As will be described in greater detail below, the wireless adapter 100 can connect to a wireless wide area network (WWAN) 20, such as a cellular network or WiMAX network, or to a wireless local area network (WLAN) 22. The WLAN 22 may comprise any local area network that can be accessed wirelessly, such as a home network with a wireless router. The WWAN 20 and/or WLAN 22 may provide connection to the Internet 24. A home computer 30 is connected to the WLAN 22. Web album 32, web blog 34, and print server 36 are connected to the Internet 24.

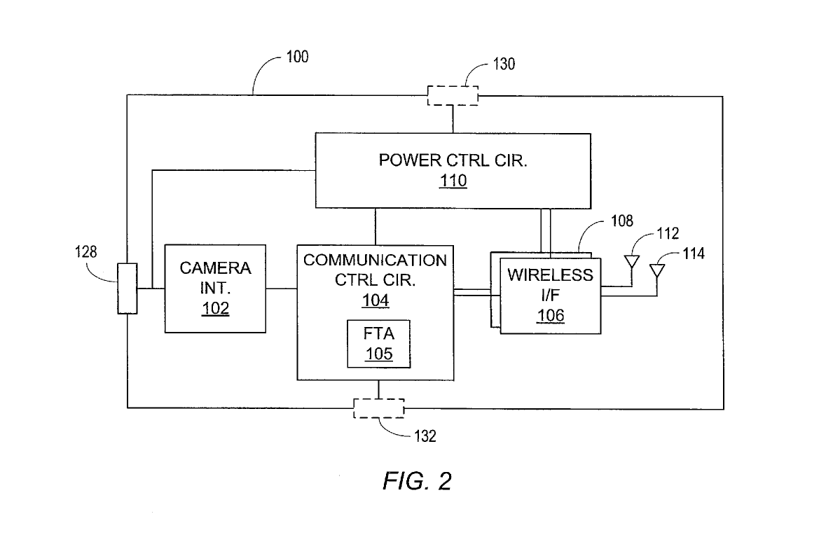

FIG. 2 shows an exemplary wireless adaptor 100. Wireless adaptor 100 includes camera interface 102, communication control circuit 104, wireless interfaces 106, 108, and power control circuit 110. Camera interface 102 provides an interface to the digital camera 10 to enable communication between the wireless adapter 100 and digital camera 10. Communication control circuit 104 comprises processing circuits and memory for implementing file transfer agent functions and controlling the overall operation of the wireless adapter as herein after described. Wireless interfaces 106, 108 enable communication over wireless network, such as WWAN 20 and WLAN 22. Power control circuit 110 manages power to the wireless adapter 100. Power can be supplied by an internal battery (not shown) or an external power source via an optional connector 130.

Camera interface 102 may comprise a serial or parallel interface, such as a Universal Serial Bus (USB) interface, a Firewire interface, etc. Connector 128 connects the camera interface 102 with the digital camera 10. In one exemplary embodiment, the camera interface 102 functions as a USB host device and the digital camera functions as a USB client device. Power may be supplied by the digital camera 10 through the camera interface 102.

In one exemplary embodiment, wireless interface 106 enables long-range communication over a WWAN 20, while wireless interface 108 enables short-range wireless communication over WLAN 22. The wireless interface 106 may comprises a standard cellular transceiver, such as a GSM or CDMA transceiver. alternatively, the wireless interface 106 may comprise a WiMAX transceiver or OFDM transceiver. Wireless interface 108 may comprise, for example, a BLUETOOTH, WiFi, RFID, or NFC interface.

The communication control circuit 104 includes a file transfer agent (FTA) 105 to provide remote access capability. The file transfer agent 105 stores information about one or more remote destinations in memory of the wireless adapter 100. Such information may include the destination address for each destination and authentication information, such as the username and password for each destination. The file transfer agent 105 is configured to receive image data from the digital camera 10 and to transfer the image data to the remote destination via one of the wireless interfaces 106, 108. An optional configuration connector 132 can be provided for connecting the communication control circuit 104 to an external computer (not shown) to configure the wireless adaptor 100.

In one embodiment, the file transfer agent 105 emulates a printer as described in related Application Ser. No. 60/863,382 filed concurrently herewith and incorporated herein by reference. In this embodiment, file transfer agent 105 implements PictBridge or other direct printing technology to communicate directly with the digital camera 10. The file transfer agent can create one or more emulated printers that appear to the digital camera 10 like any other printer. Each emulated printer is associated with a particular remote destination. When the user “prints” to an emulated printer, the file transfer agent 105 transfers the image data to a corresponding remote destination. By emulating a printer, the file transfer agent 105 provides networking capabilities to any digital camera 10 that implements Pictbridge or other direct printing technology.

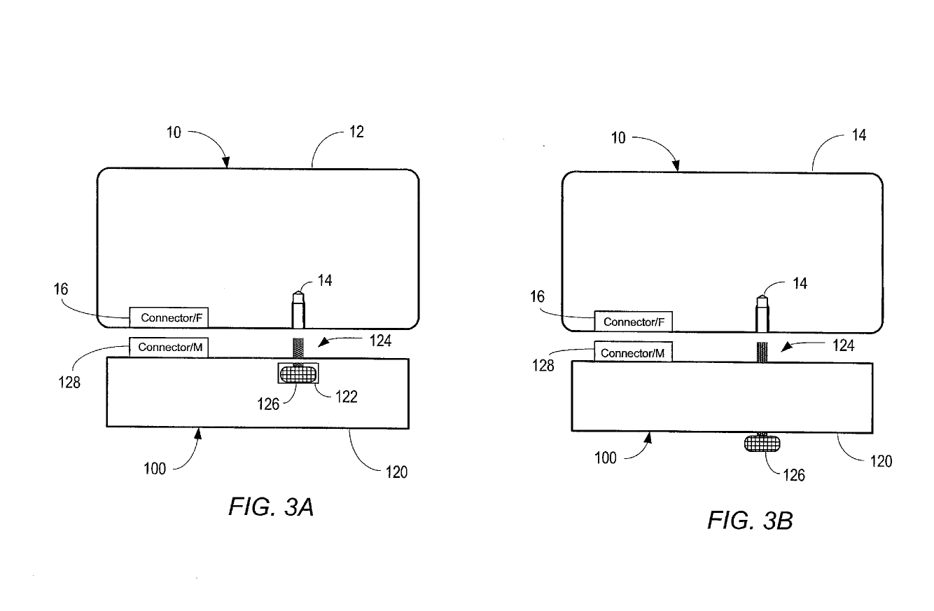

FIGS. 3A and 3B illustrate a first exemplary method for connecting the wireless adapter 100 with the digital camera 10. Both mechanical connections and electrical connections are shown. Mechanical connection is made by means of threaded connectors. The camera body 12 for the digital camera 10 includes a conventional tripod connector 14 with internal threads for mounting the digital camera 10 to a tripod (not shown). The wireless adapter body 120 includes a mounting screw 124 that threads into the tripod connector 14 on the camera body 12. The mounting screw 124 on the wireless adapter body includes a finger grip 126 that can be accessed through a window 122 in the wireless adapter body 120 as shown in FIG. 3A. Alternatively, the mounting screw 124 can pass through the wireless adapter body 120 as shown in FIG. 3B.

Electrical connection between the camera 10 and wireless adapter 100 is made by means of mating connectors. A female connector 16 is disposed on the camera body 12 and the male connector 128 is disposed on the wireless adapter body 120. The spacing and relative orientation between the male connector 128 and the mounting screw 124 on the wireless adapter body 120 is the same as the spacing and relative orientation between the female connector 16 and the tripod connector 14 on the camera body 12.

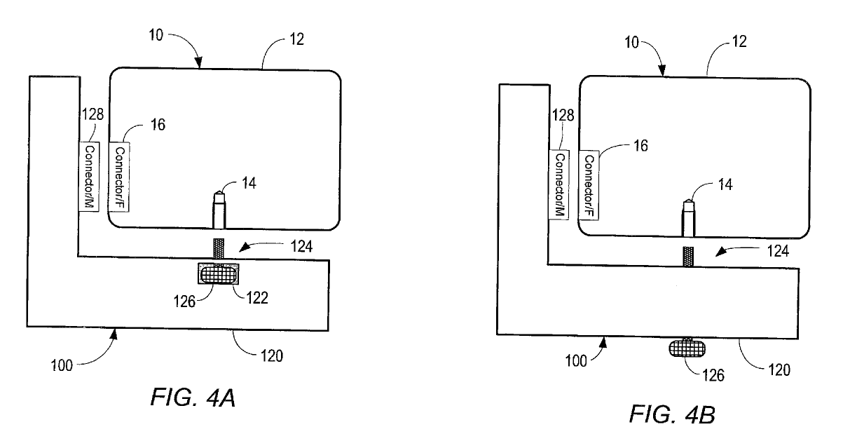

FIGS. 4A and 4B illustrate a second exemplary method of connecting the wireless adapter 100 with the digital camera 10. The camera body 12 includes a tripod connector 14 as previously described on a bottom surface, and a female connector 16 along one side of the digital camera 10. The wireless adapter 100 extends along two sides of the digital camera 10. The wireless adapter 100 includes a mounting screw 124 and male connector 128 for connecting to the digital camera 10 as previously described. FIG. 4A shows an embodiment in which the mounting screw 124 is accessed through a window 122 in the wireless adapter body 120. FIG. 4B shows an embodiment in which the mounting screw 124 passes through the wireless adapter body 120.

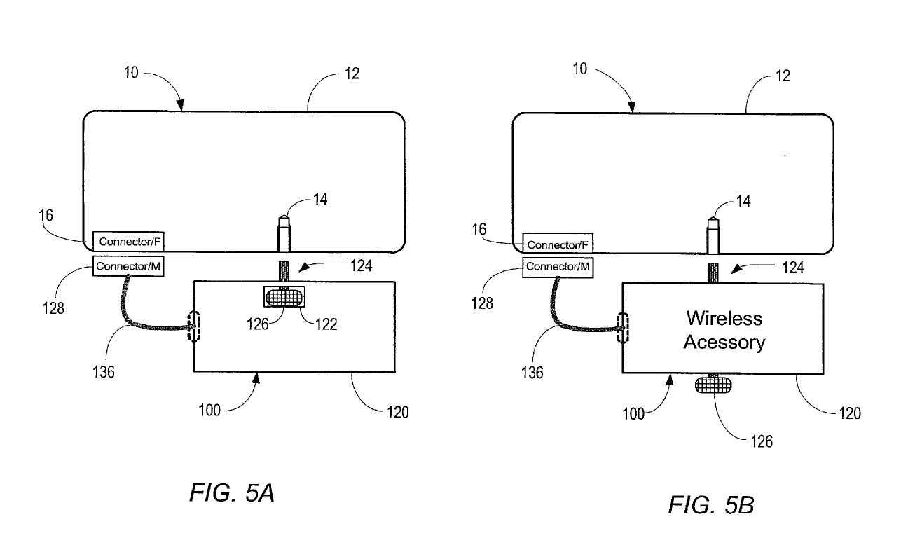

FIGS. 5A and 5B illustrate a third method for connecting the wireless adapter 100 to the digital camera 10. As in the two previous embodiments, the wireless adapter body 120 includes a mounting screw 124 adapted to engage with a tripod connector 14 on the camera body 12. The mounting screw 124 may be accessed through a window 122 in the adapter body as shown in FIG. 5A, or may pass through the wireless adapter body 120 as shown in FIG. 5B. The electrical connection is made by means of a cable connector 136 having a male connector 128 at one end thereof that engages a female connector 16 on the camera body 12. FIGS. 5A and 5B illustrate a fixed cable. Those skilled in the art will appreciate, however, that an additional connector (not shown) may be provided for disconnecting the cable connector 136 from the wireless adapter body.

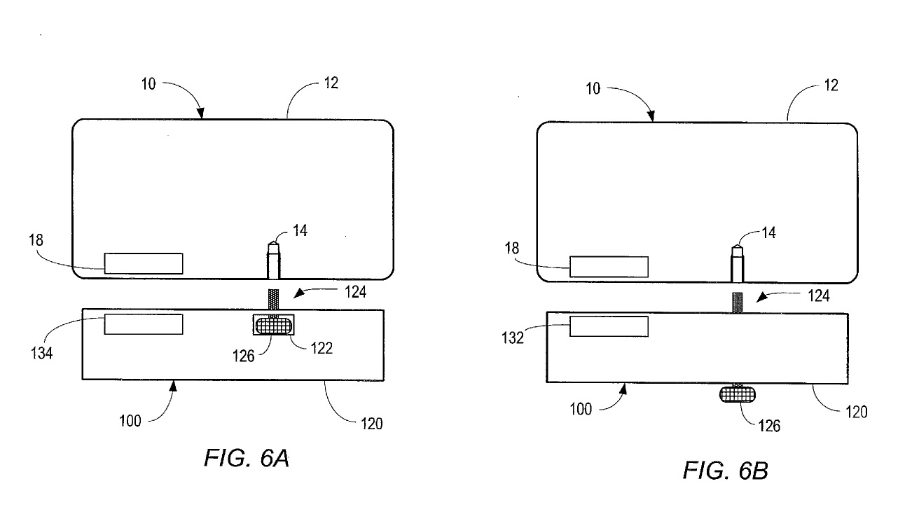

FIGS. 6A and 6B illustrate a fourth method of connecting the wireless adapter 100 to the digital camera 10. The wireless adapter body 120 includes a mounting screw 124 adapted to engage with a tripod connector 14 on the camera body 12 as previously described. The mounting screw 124 may be accessed through a window 122 in the adapter body as shown in FIG. 6A, or may pass through the wireless adapter body 120 as shown in FIG. 6B. The electrical connection is made by a short-range wireless interfaces 18,134. Short-range wireless interface 18, 134 may comprise such a near-filed communication (NFC) interface, or BLUETOOTH interface.

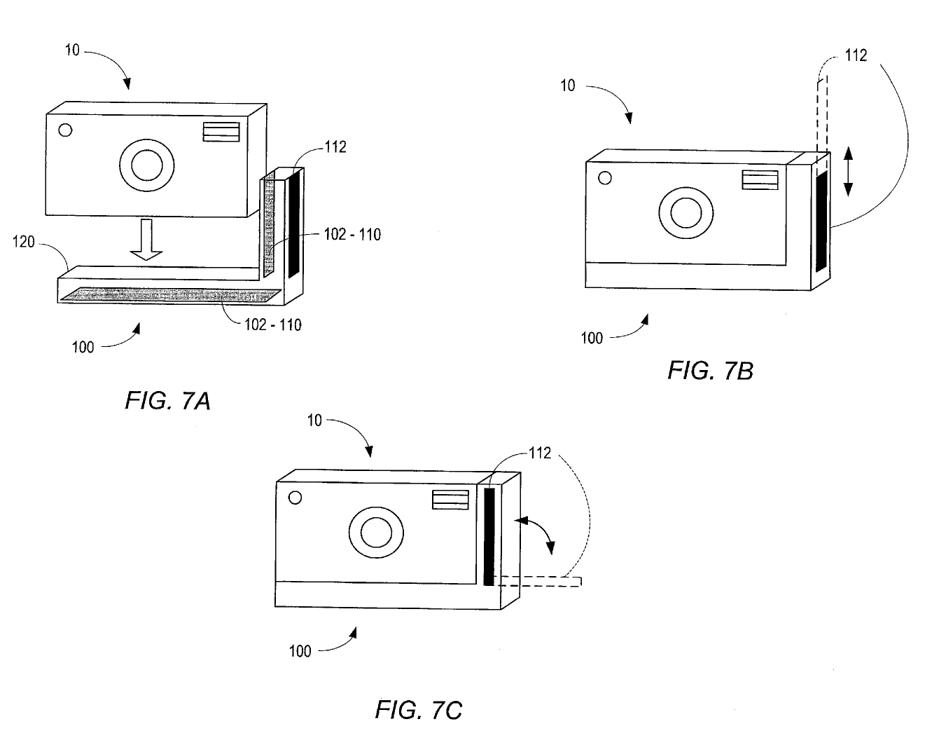

FIGS. 7A-7C illustrate exemplary antenna arrangements for the wireless adapter 100. As shown in FIG. 7A, the circuits in wireless adaptor 100 may be disposed in a bottom and/or side portion of the adaptor 100. The wireless adapter 100 in the illustrated embodiment extends along two sides of the digital camera 10. The bottom portion of the wireless adapter body 120 contains the mounting hardware and electrical circuits 102-110 for the wireless adapter 100. The antenna 112 is contained within or mounts to the side portion of the wireless adapter body 120. The side portion may, if desired, include part of the electrical circuitry 102-110. The antenna 112 may be fixed in place as shown in FIG. 7A. Alternatively, the antenna may slide between retracted and extended positions as shown in FIG. 7B. In another embodiment, shown in FIG. 7C, the antenna 112 is pivotally connected to the wireless adapter body 120 and pivots between retracted and extended positions.

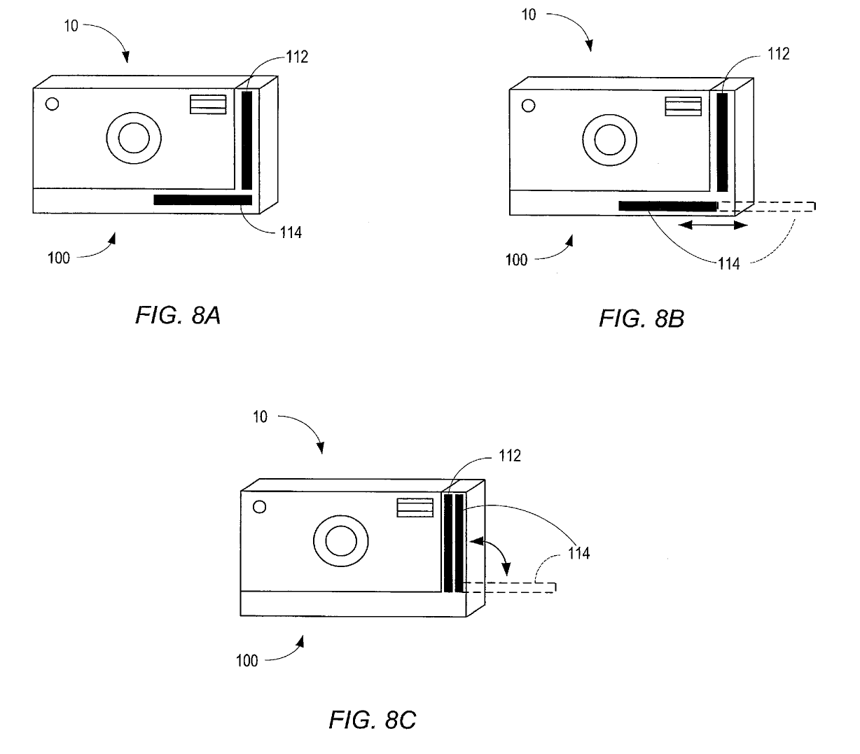

FIGS. 8A-8C illustrate an embodiment in which the wireless adapter 100 includes two antennas 112 and 114. The two antennas 112, 114 may be used for transmitting in different frequency bands or may be used to provide diversity. In FIG. 8A, the first antenna 112 is disposed on the side portion of the wireless adapter 100 as previously described, and a second antenna 114 is disposed on the bottom portion of the wireless adapter 100. The antennas 112, 114 may be fixed or movable. If movable, the antennas 112, 114 may slide or pivot between retracted and extended positions.

FIG. 8B illustrates an embodiment of the wireless adaptor having a fixed antenna 112 disposed on the side portion of the wireless adaptor 100 and a second movable antenna disposed on the bottom portion of the wireless adaptor 100. The movable antenna 114 may slide between retracted and extended positions.

FIG. 8C illustrates an embodiment of the wireless adapter 100 having two antennas 112, 114 disposed on the side portion of the wireless adapter 100. The first antenna 112 is a fixed antenna and the second antenna 114 is a movable antenna. The movable antenna 114 pivots between retracted and extended positions.

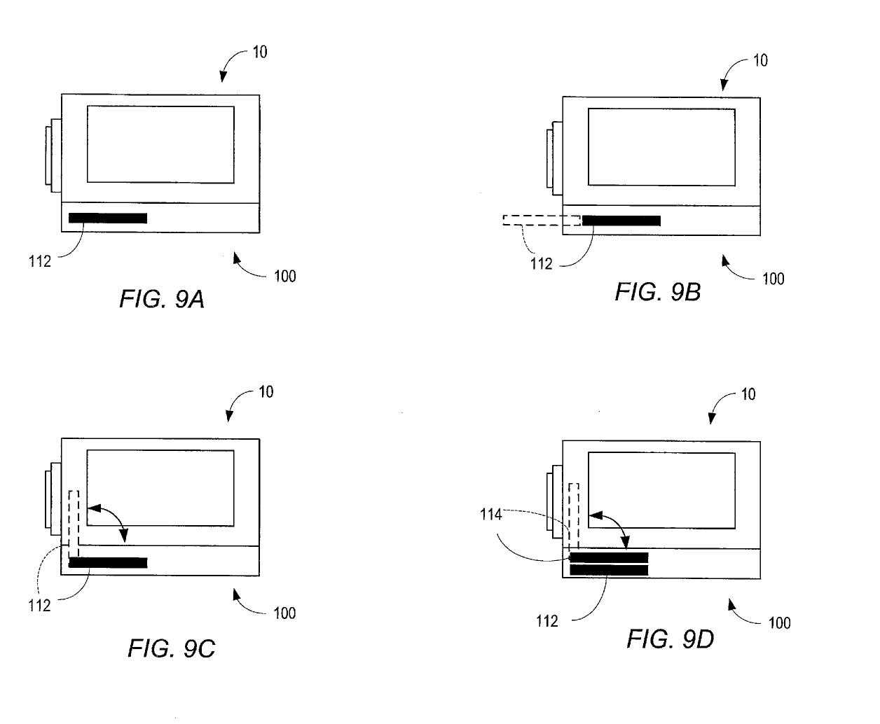

FIGS. 9A-9D show embodiments of the wireless adapter 100 for a digital video camera 10. The wireless adapter 100 in these embodiments is adapted to mount to a bottom surface of the digital video camera 10. The wireless adapter 100 can be connected to the digital video camera 10 using the methods previously described and shown in FIGS. 3-6. In FIG. 9A, the antenna 112 for the wireless adapter 100 is disposed toward a front end of the wireless adapter. FIG. 9B shows a slidable antenna 112 that slides between extended and retracted positions. FIG. 9C shows a pivoting antenna 112 that pivots between extended and retracted positions. FIG. 9D shows an embodiment of the wireless adapter 100 for a digital video camera 10 having two antennas 112, 114. A first antenna 112 is fixed at the front end of the wireless adapter 100. A second antenna 114 is mounted for pivotal movement between extended and retracted positions. It will be appreciated that the second antenna 114 could also slide between extended and retracted positions.

The present invention may, of course, be carried out in other ways than those specifically set forth herein without departing from essential characteristics of the invention. The present embodiments are to be considered in all respects as illustrative and not restrictive, and all changes coming within the meaning and equivalency range of the appended claims are intended to be embraced therein.

What is claimed is:

1. A wireless adapter for a digital camera comprising:
a wireless interface for communicating with remote devices;
a housing for enclosing said wireless interface;
a connector on said housing to detachably connect the wireless adapter to a digital camera;
a camera interface to electrically connect the wireless adapter with the digital camera.

2. The wireless adapter of claim 1 wherein the camera interface includes an electrical connector to connect with a corresponding electrical connector on said digital camera.

3. The wireless adapter of claim 1 wherein the camera interface comprises a serial interface.

4. The wireless adapter of claim 1 wherein said connector comprises a mounting screw that screws into a tripod connector on said digital camera.

5. The wireless adapter of claim 1 including at least one antenna coupled to said wireless interface.

6. The wireless adapter of claim 5 wherein the antenna is a fixed antenna.

7. The wireless adapter of claim 6 wherein the antenna is movable between extended and retracted positions.

8. The wireless adapter of claim 7 wherein the antenna is mounted for sliding movement between the extended and retracted positions.

9. The wireless adapter of claim 7 wherein the antenna is mounted for pivotal movement between the extended and retracted positions.

10. The wireless adapter of claim 5 wherein said housing includes a bottom portion that extends along a bottom of the digital camera and a side portion that extends along a side of said digital camera, and wherein said antenna is mounted to said side portion of said housing.

11. The wireless adapter of claim 5 including two antennas coupled to said wireless interface.

12. The wireless adapter of claim 11 wherein said two antennas operate in different frequency bands.

13. The wireless adapter of claim 12 wherein the said two antennas are diversity antennas.

14. The wireless adapter of claim 11 wherein one antenna is a fixed antenna and one antenna is a movable antenna.

15. The wireless adaptor of claim 14 wherein the two antennas are orthogonal to each other before and after the second antenna is moved.

16. The wireless adaptor of claim 14 wherein the two antennas are parallel to each other before the second antenna is moved and orthogonal to each other after the second antenna is moved.

17. The wireless adaptor of claim 14 wherein the movable antenna is mounted for sliding movement between extended and retracted positions.

18. The wireless adaptor of claim 14 wherein the movable antenna is mounted for pivotal movement between extended and retracted positions.

19. The wireless adapter of claim 11 wherein said two antennas are orthogonal to one another.

20. The wireless adapter of claim 11 wherein said housing includes a bottom portion that extends along a bottom of the digital camera and a side portion that extends along a side of said digital camera, and wherein a first one of said antennas is disposed in said side portion of said housing and a second one of said antennas is mounted to said bottom portion of said housing.

21. The wireless adaptor of claim 1 further comprising a file transfer agent configured to transfer image data from the digital camera to a remote destination.

22. The wireless adaptor of claim 21 wherein the file transfer agent is configured to emulate a printer and to transfer the image data to the emulated printer such that the image data is transmitted to one of the remote devices via the wireless interface.
